(19) United States
(12) Patent Application Publication
(10) Pub. No.: US 2015/0259874 A1
(43) Pub. Date: Sep. 17, 2015

(54) Locking Mechanism

(71) Applicant: GEITH INTERNATIONAL LIMITED, Grangegeeth, Slane, Co. Meath (IE)

(72) Inventors: Andrew Cunningham, Grangegeeth (IE); Anthony McKeown, Grangegeeth (IE)

(21) Appl. No.: 14/426,843

(22) PCT Filed: Aug. 19, 2013
(86) PCT No.: PCT/EP2013/067237

§ 371 Date: Mar. 9, 2015

(30) Foreign Application Priority Data
Sep. 10, 2012 (GB) 1216102.2

(51) Int. Cl. E02F 3/36; F16C 11/04; F16H 25/24

(52) U.S. Cl. CPC E02F 3/365; F16H 25/2454; F16C 11/04

(57) ABSTRACT

A locking mechanism for use in a quick hitch coupling device for coupling an attachment to a mechanical arm of, for example, an excavator. The invention is particularly but not exclusively concerned with a locking mechanism for a quick hitch coupling device comprising a safety system for automatically retaining the coupler in a locked arrangement.

### FIELD OF THE INVENTION

The present invention relates to a locking mechanism for use in a quick hitch coupling device for coupling an attachment to a mechanical arm of, for example, an excavator. More particularly, but not exclusively, the present invention relates to a locking mechanism for a quick hitch coupling device comprising a safety system for automatically retaining the coupler in a locked arrangement.

### BACKGROUND TO THE INVENTION

Coupling devices for coupling accessories to hydraulically operated arms of excavator machinery are well known. These devices are typically used to attach different types of attachments to a mechanical arm (commonly referred to as the “dipper arm”) of such apparatus. Such attachments may include, but are not limited to, a jack hammer, or different sizes of buckets.

The coupling device (also commonly referred to as a “coupler” or “quick hitch”) is usually releasably attachable to both the (dipper) arm of an excavator and the attachment. The quick hitch is adapted for attachment to the arm and normally would remain on the arm and be utilised to interchangeably couple different attachments to the arm. Typically, quick hitches come in one of two configurations: “pin couplers”, and “dedicated couplers”.

Dedicated couplers are usually configured to interact only with attachments bearing complementary components, these complementary components often comprising combinations of plates and holes. Pin couplers, on the other hand, are designed to work in conjunction with any attachment bearing a pair of spaced apart coupling pins typically used for connecting to arms.

Pin couplers comprise a body member adapted for coupling to the arm, and a pair of engagement members that are provided for releasably engaging the pair of spaced apart coupling pins located on the attachment. One engagement member typically is moveable relative to the other engagement member between an engaged state and a disengaged state. In the engaged state, the engagement members co-operate such that each engagement member securely engages a respective coupling pin, thereby securely coupling the attachment to the dipper arm. In the disengaged state, the engagement members are positioned relative to one another such that the coupling pins are not securely engaged, and the attachment can thereby be released from the dipper arm. The engagement members are formed, for example, by a set of hooks, typically at least two hooks. Typically, the moveable engagement member is either slideably or pivotally connected to the body member and is moveable between the engaged and disengaged states by a ram, for example, a hydraulic means such as a hydraulic ram, or by mechanical means, such as a ram comprising a screw threaded piston, a linkage or a lever. Pin couplers comprising hydraulic means, and dedicated couplers analogously comprising hydraulic means will herein be referred to as “hydraulic couplers”, whereas pin couplers comprising mechanical means, and dedicated couplers analogously comprising mechanical means will herein be referred to as “mechanical couplers”.

Pin couplers and dedicated couplers suffer from a number of disadvantages.

For example, different attachments may be produced by different manufacturers, and while most attachments use the two coupling pin mechanism described (i.e. suited for use in conjunction with pin couplers), the spacing between the coupling pins can differ from manufacturer to manufacturer. This can cause a problem for many pin coupler quick hitch devices that comprise engagement members designed to securely engage coupling pins of only one particular spacing, reducing the number of compatible attachments available.

Furthermore, for hydraulic couplers, should the hydraulic fluid supply to the hydraulic ram fail in general, the moveable engagement member returns to its disengaged state thereby releasing the attachment. This can have serious consequences, which can result in fatal accidents should the hydraulic supply to the quick hitch coupler fail when the attachment is in an elevated state with a person standing beneath it, in that the attachment could fall on the person. It will be appreciated that it is difficult for an operator to determine without leaving his cab whether the attachment is safely secured to the quick hitch coupler.

To avoid the inadvertent or accidental release of the attachment by releasing the grip of the coupler on the attachment, locking systems have been incorporated into existing coupling systems to ensure that the attachment is only released when it is desired to do so. Mechanical locks have been provided on couplers that require the operator of the machine (or another person) to manually release the mechanical lock. Such mechanical locks have been provided in both mechanical and hydraulic couplers. However, the operator must get out of the excavator machine to operate the lock, and this is not always done. A problem therefore arises when the operator of the excavator neglects to engage the lock after connecting an attachment to an excavator arm.

Alternatively, a hydraulically operated lock is provided. Hydraulic locks can be activated automatically, at the same time that the coupler is activated to engage the attachment. However, hydraulic locks are best suited to couplers that use hydraulic means to move the moveable engagement member and are unsuited to couplers that use mechanical means to move the moveable engagement member. One of the main reasons a mechanical coupler might be selected over a hydraulic coupler is that mechanical couplers are cheaper to produce and maintain. To have a hydraulic powered lock on a mechanically operated coupler would require the installation of a hydraulic supply circuit to the lock thereby changing the mechanical system to a hydraulic system, incurring additional cost of parts and installation. This would negate many of the benefits of mechanical couplers. As such, mechanical couplers are typically paired with mechanical locks, and hydraulic couplers are typically paired with hydraulic locks.

In addition, some quick hitch coupling devices that comprise locking systems are difficult to manufacture in a typical engineering machine shop without specific machining equipment, and as such, are expensive and inconvenient to manufacture. In some cases, some of the components require a specific heat treatment process to be carried out, and this can also cause problems, since the components may fail if the heat treatment is not carried out consistently and correctly.

European Patent No. 1318242 discloses a quick hitch coupling device capable of engaging with attachments having pairs of coupling pins that are spaced apart to various degrees. The coupling device comprises a body member, a fixed engagement member, a moveable latch member co-operable with the fixed engagement member for retaining a first coupling pin, and a movable engagement member for retaining a second coupling pin. The latch member is moveable between a latched and an unlatched state, and the moveable engagement member is moveable between an engaged and a disengaged state, wherein the latch member and the moveable engagement member are actuatable by a common actuator. The common actuator may alternate the coupling device between an engaged configuration and a disengaged configuration. In the engaged configuration, the latch member has been moved to the latched state by the common actuator, and the moveable engagement member has been moved to the engaged state by the common actuator. In the disengaged configuration, the latch member has been moved to the unlatched state and the moveable engagement member has been moved to the disengaged state.

Notwithstanding the above prior art, it would be preferable to provide a quick hitch coupler that couples with attachments having pairs of coupling pins that are spaced apart to various degrees, and also to provide a quick hitch coupler that prevents accidental disengagement of the attachment without suffering from any of the drawbacks alluded to above.

### SUMMARY OF THE INVENTION

An embodiment of a first aspect of the invention comprises an extendable mechanism, moveable through a plurality of states, wherein the plurality of states comprises at least a first state and a second state, the mechanism comprising: a force receiving member wherein application of a force of a first type to the force receiving member results in the extendable mechanism moving toward the first state, and wherein application of a force of a second type to the force receiving member results in the mechanism moving toward the second state, and a locking member in communication with the force receiving member, the locking member moveable between a locked configuration and an unlocked configuration; the mechanism characterised in that: when in the locked configuration, the locking member restricts movement of the extendable mechanism toward the first state; and further characterised in that application of the first type of force to the force receiving member results in the locking member moving to the unlocked configuration; and application of the second type of force to the force receiving member results in the locking member moving to the locked configuration.

As such, when it is intended to move the extendable mechanism toward the second state, the second type of force will be applied. Through application of this second type of force, the locking member is automatically moved into the locked state, and will remain in the locked state after the force has been applied, thereby restricting the extendable member from unintentionally returning toward the first state. When it is intended to move the extendable mechanism toward the first state, the first type of force will be applied. Through application of this first type of force, the locking member is automatically moved to the unlocked state, thereby permitting the extendable mechanism to move toward the first state. Accordingly, engagement/disengagement of the locking member is integrated into the process of moving the extendable mechanism between the first and second states. As a result, it is impossible to forget to engage the locking member.

The first state may be a retracted state, and the second state may be an extended state. The force receiving member may be configured to rotate about an axis, wherein the first type of force may be a first torque, and the second type of force may be a second torque, the first and second torques being torque of opposing rotations. For example, the first type of force may be clockwise torque, and the second type of force may be anticlockwise torque.

The extendable mechanism may comprise a mechanical ram comprising a cylinder body and a ram rod, wherein rotation—relative to the cylinder body—of the ram rod about its longitudinal axis causes the ram rod to move relative to the cylinder body along the longitudinal axis of the cylinder body.

The force receiving member and the locking member may be in communication with the ram rod, such that: first torque applied to the force receiving member is transferred to the ram rod, urging the ram rod to rotate in a first direction, such that the extendable mechanism would move toward the first state; second torque applied to the force receiving member is transferred to the ram rod, urging the ram rod to rotate in a second direction, such that the extendable mechanism would move toward the second state; and when in the locked configuration, the locking member restricts rotation of the ram rod in the first direction. In this way, the force receiving member and the locking member may be integrated into the ram rod, allowing for a more compact system.

The mechanism may further comprise a biasing means configured to urge the locking member against the force receiving member, such that: application of the first type of force to the force receiving member urges the force receiving member against the locking member, urging the locking member against the biasing means in turn, such that the locking member is moved to the unlocked configuration; and application of the second type of force to the force receiving member urges the force receiving member away from the locking member wherein the biasing means further urges the locking member against the force receiving member, such that the locking member is moved to the locked configuration. The biasing means may comprise a compression spring.

The mechanism may be incorporated into a coupling device for coupling an attachment to an arm. The mechanism may be comprised in a quick hitch coupler. The mechanism may alternatively be comprised in a dedicated coupler. The mechanism may be comprised in an excavator arm comprising. The mechanism may be comprised in an excavator.

An embodiment of another aspect of the invention comprises a quick hitch coupler comprising: a coupler body, defining at least one fixed mouth; a latch member having a first end and a second end, and pivotally attached at the first end to the coupler body, the latch member moveable between an unlocked position, and a locked position, wherein in the locked position the latch member restricts egress from the at least one fixed mouth; an engagement member defining at least one moveable mouth, the engagement member moveable relative to the coupler body between a first position where the at least one moveable mouth is proximate to the at least one fixed mouth, and a second position where the at least one moveable mouth is distant from the at least one fixed mouth; and an extendable mechanism moveable through application of mechanical force between an extended and a refracted state, the mechanism having a first end and a second end, the first end of the mechanism retained in the coupler body and connected to a second end of the latch member, and the second end of the mechanism rotatably connected at a second end to the engagement member, wherein movement of the extendable mechanism toward its retracted state results in the movement of the engagement member toward its first position and movement of the latch member to its locked position, and movement of the extendable mechanism toward its extended state results in the movement of the engagement member toward its second position and movement of the latch member to its unlocked position.

Use of the latch member in conjunction with an extendable mechanism to which mechanical force is to be applied obviates any danger of accidental disengagement in event of hydraulic failure, as is often associated with hydraulic coupler systems. Furthermore, use of the latch member in conjunction with an extendable mechanism to which mechanical force is to be applied provides a mechanical locking mechanism for a mechanical system, obviating the need for hydraulic circuitry and preserving the benefits of having a mechanical-only system.

The latch member may comprise at least two links pivotally connected at a common pivot point, wherein in the locked position, the portion of the latch member comprising the common pivot point restricts egress from the at least one said mouth.

The latch member may comprise a parallel pair of connector links and a latch link, each connector link comprising a first end and a second end, characterised in that: the first ends of the connector links are connected to the latch link at the common pivot point; the second ends of the connector links together comprise the second end of the latch member such that the second ends of the connector links are each pivotally connected to opposing sides of the first end of the extendable mechanism, the latch link comprises the first end of the link member; and the extendable mechanism is slidably retained in the coupler body.

Such a latch configuration provides a strong and robust locking mechanism, because the latch does not comprise a free end and a single pivoting connection, but a single broad latch that is pivotally connected to the system at two separate axes of rotation.

The extendable mechanism of this aspect of the invention may comprises the extendable mechanism of the previously stated embodiment of the first aspect of the invention, wherein the first end of the extendable mechanism comprises the cylinder body, and the second end of the extendable mechanism comprises the ram rod.

### BRIEF DESCRIPTION OF THE DRAWINGS

FIG. 1 is a perspective view of an excavator comprising a dipper arm as is known in the art;

FIG. 2 is a cutaway perspective view of a coupler in accordance with an aspect of the invention;

FIG. 3 is a cutaway perspective view of the coupler of FIG. 2;

FIG. 4 is a side view of the coupler of FIG. 2 in an engaged state;

FIG. 5 is a side view of the coupler of FIG. 2 in a disengaged state;

FIG. 6 is an exploded cutaway perspective view of the mechanical ram comprised in the coupler of FIG. 2;

FIG. 7 is an exploded perspective view of the coupler of FIG. 2;

FIG. 8 is an exploded perspective view of the ram and moveable engaging means assembly of the coupler of FIG. 2;

FIG. 9 is a cross sectional view of the moveable engaging means and free end of the ram rod of the coupler of FIG. 2 in a locked position;

FIG. 10 is a cross sectional view of the moveable engaging means and free end of the ram rod of the coupler of FIG. 2 in an unlocked position;

FIG. 11 is a perspective view of the moving lock bush comprised in the coupler of FIG. 2;

FIG. 12 is a perspective view of the fixed lock bush comprised in the coupler of FIG. 2;

FIG. 13 is a perspective view of the lock nut comprised in the coupler of FIG. 2;

### DETAILED DESCRIPTION OF THE DRAWINGS

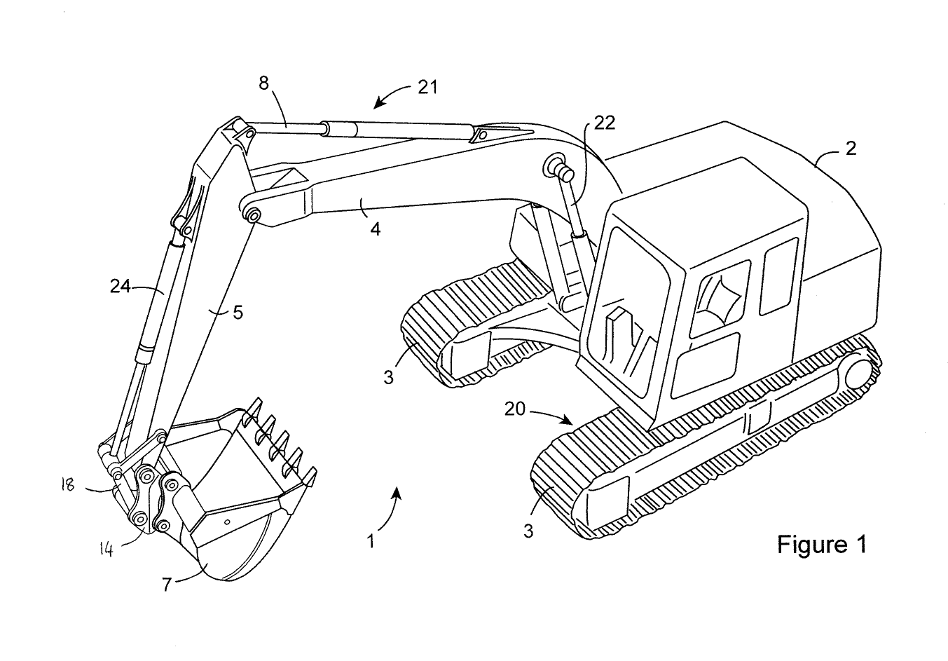

Referring to the drawings and initially to FIG. 1, there is illustrated an excavator apparatus according to the invention indicated generally by the reference numeral 20. The apparatus 20 comprises a main housing 2 that is carried on a main chassis, which in turn is carried on ground engaging tracks 3. The main housing 2 is mounted on a sub-housing that is rotatably carried on the main chassis 3 about a vertically extending axis, so that the sub-housing and the main housing 2 are rotatable through 360° relative to the main chassis. This aspect of such excavator apparatus will be well known to those skilled in the art. A back actor arm 21 is mounted on the sub-chassis and comprises a boom 4 that is pivotally connected to the sub-chassis and extends upwardly therefrom. A dipper arm 5 is pivotally carried on the boom 4 for in turn pivotally carrying an accessory, which in this embodiment of the invention is an earth moving bucket 7. The distal (free) end of the dipper arm 5 is adapted to enable attachment of accessories. A quick hitch coupler according to the invention and indicated generally by the reference numeral 14 releasably hitches the bucket 7 to the dipper arm 5. The quick hitch coupler 14 is described in detail below. A pair of boom operating rams 22 acting between the sub-chassis and the boom 4 operate the boom 4 for raising and lowering the boom 4 about its pivot connection to the sub-chassis. A dipper arm operating ram 8 acting between the boom 4 and the dipper arm 5 pivots the dipper arm 5 relative to the boom 4. The ram 8 controls the reach of the dipper arm 5 by controlling the angle of the dipper arm 5 relative to the boom 4. However the operation of a boom and dipper arm of such excavator apparatus will be well known to those skilled in the art, and it is not intended to describe this aspect of the invention further.

A pivotally mounted connecting linkage 18 is pivotally connected by a pair of pivot pins to the dipper arm 5 towards the distal end thereof. An accessory operating (or crowd) ram 24 acting between the dipper arm 5 and the connecting linkage 18 is provided for pivoting the connecting linkage 18 for in turn pivoting the bucket 7 relative to the dipper arm 5. The angle of the coupler 14 relative to the arm 21 (and in particular relative to the dipper arm 5) is therefore controlled by the hydraulic ram 24, as is well known in the art.

A pair of coupling pins, namely, a first coupling pin and a second coupling pin (not shown) are provided on the bucket 12, or indeed, on any other accessory to be connected to the dipper arm 5, for engagement with the quick hitch coupler 14 as will be readily appreciated by those skilled in the art.

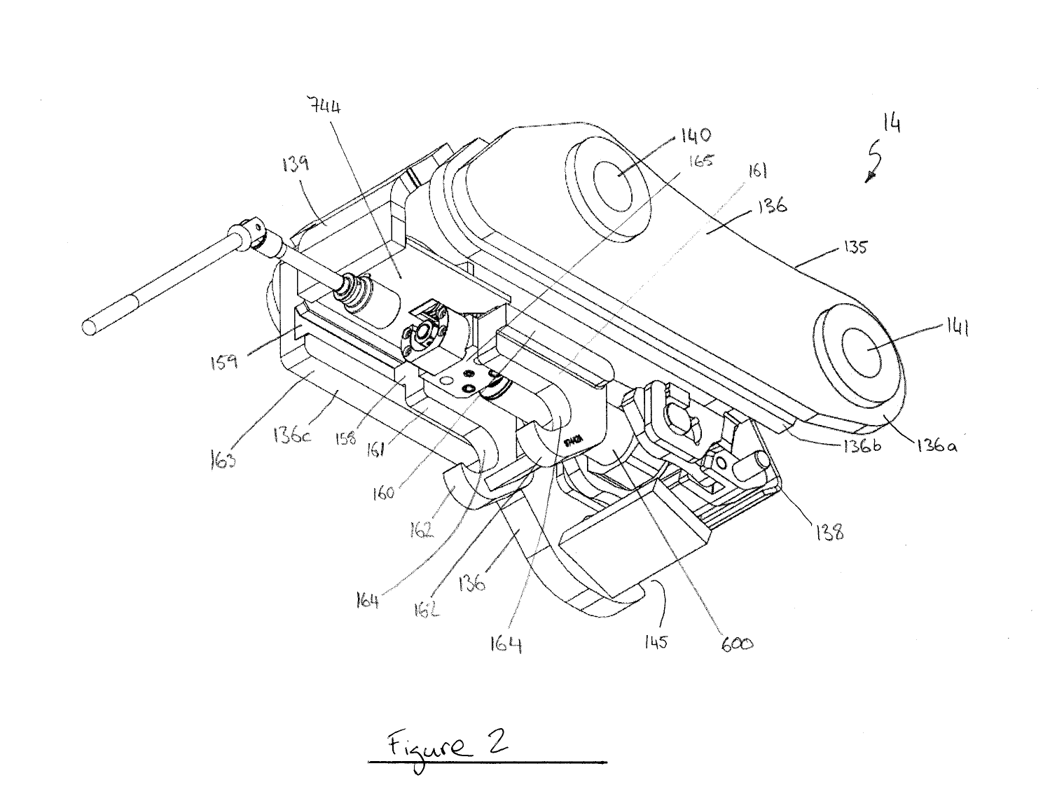

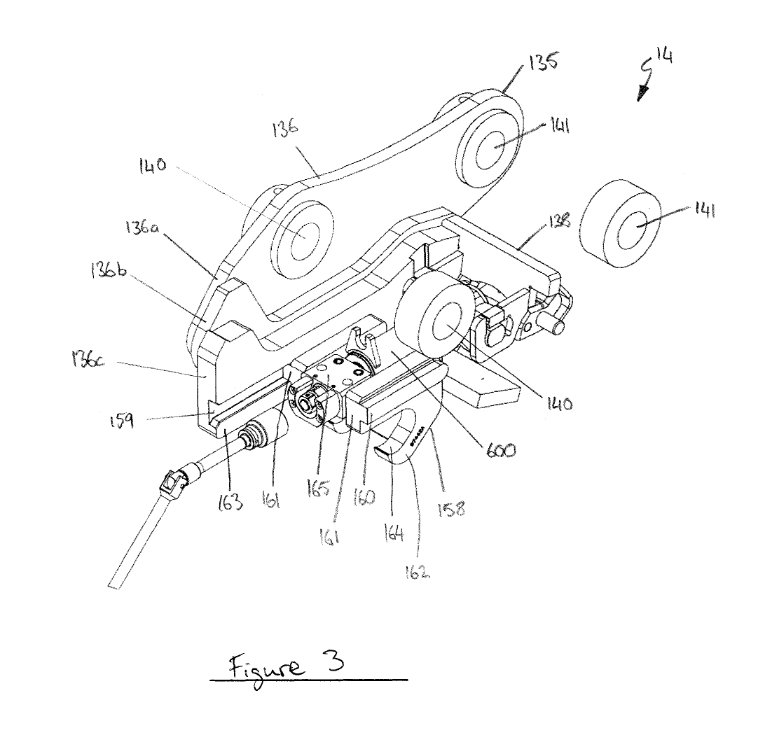

Referring now in particular to FIGS. 2 to 5, the quick hitch coupler 14 according to one embodiment of the invention comprises a body member 135 formed by a pair of spaced apart side plates 136, typically made of steel, and a transversely extending pair of connector plates—a posterior connector plate 138 and an anterior connector plate 139—also typically made of steel, extending between the adjoining side plates 136 at opposite ends of the plates. The side plates 136 each comprise a main side plate 136c and reinforcing side plates 136b and 136a welded together. However, for convenience the combination of the main and reinforcing side plates 136a, 136b and 136c are referred to as the side plates 136. As FIG. 2 is a cutaway view, one of the main side plates 136c is not shown. As FIG. 3 is also a cutaway view one of the main side plates 136c along with one each of both of the reinforcing side plates 136a, 136b are also not shown. The pair of connector members 138 and 139 are welded to the side plates 136.

A connecting means for connecting the quick hitch coupler 14 to the dipper arm 5 and the connecting linkages 18 comprises two pairs of bushed bores 140 and 141 one of each pair extending through each side plate 136. The bushed bores 140 in the side plates 136 are aligned with each other for in turn aligning with the bushed bores in the connecting linkages 18 for engagement with the first connector pin 25. The bushed bores 141 in the respective side plates 136 are aligned with each other for in turn alignment with the bushed bore through the dipper arm 5 for engagement with the second connector pin 28. In this way the quick hitch coupler 14 is connected to the dipper arm 5 and the connecting linkages 18, and is thus pivotable about the second connector pin 28 by the connecting linkages 18 under the action of the accessory operating ram 24 for in turn pivoting the coupler 14 and any attached accessory.

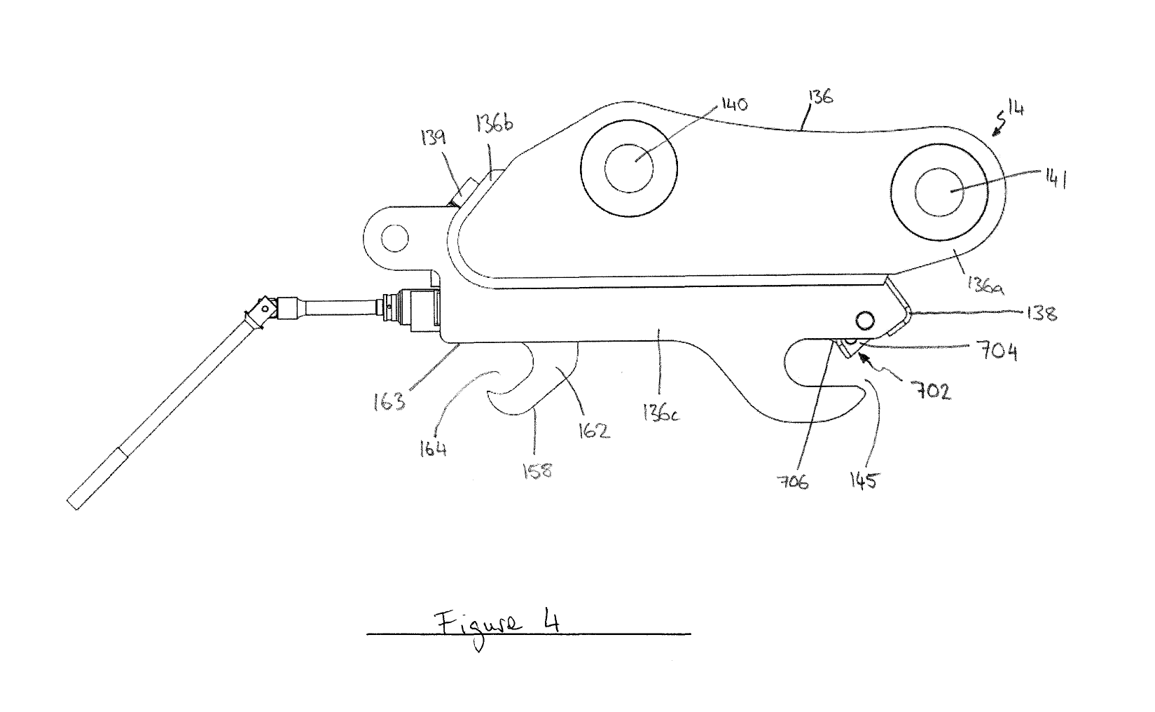

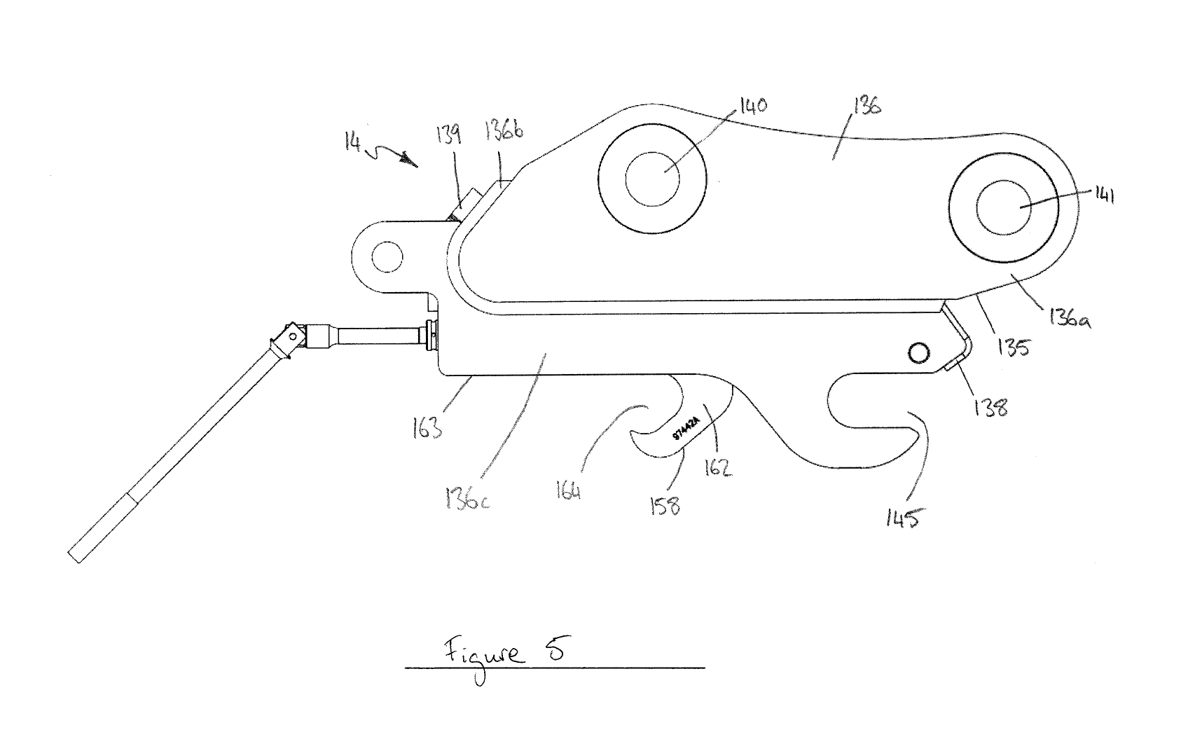

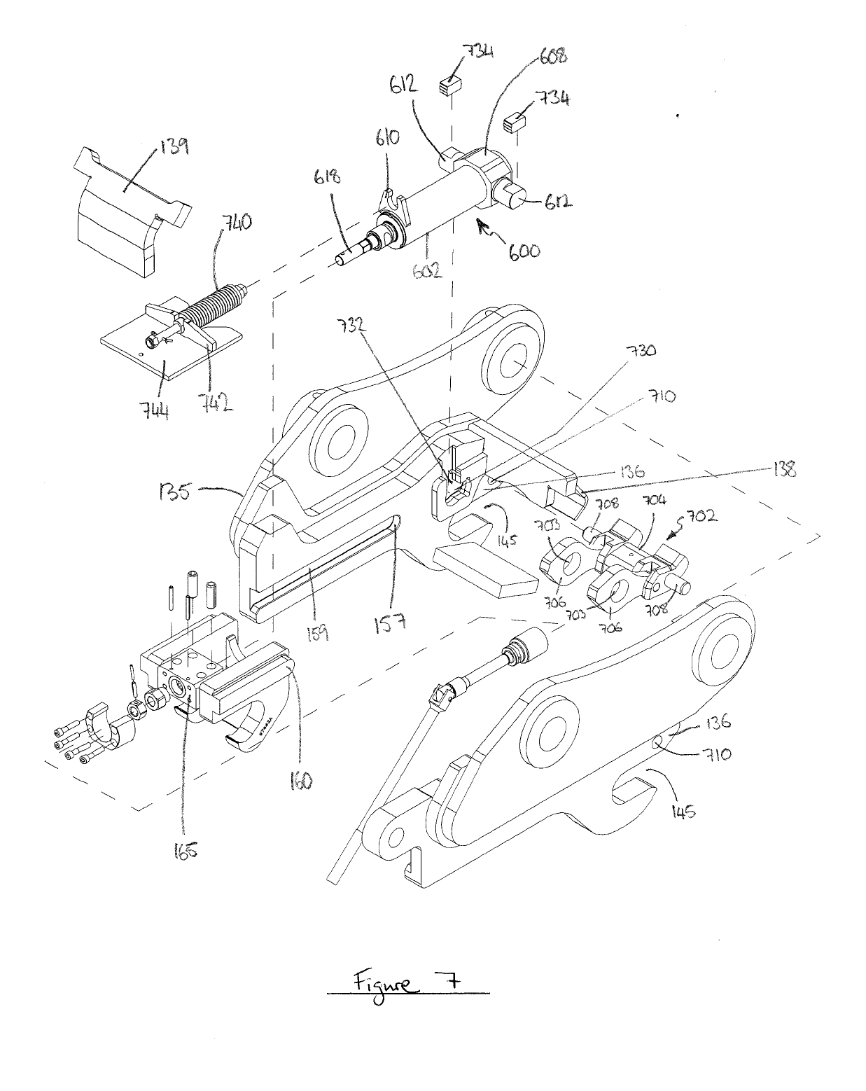

Each side plate 136 (in this embodiment, each main side plate 136c) further comprises a fixed pair of jaws defining a fixed open mouth 145. As only one main side plate 136c is shown in FIG. 2 and FIG. 3, likewise only one fixed open mouth is shown. The fixed mouths 145 in each side plate are aligned with each other such that together they form a fixed engagement member for engaging a first coupling pin of an accessory. A moveable engaging means or engagement mechanism is provided by a moveable engagement member 158 slideably carried in the body member 135, and is slideable between an engaged state as illustrated in FIG. 4 for engaging a second coupling pin of an accessory, and a disengaged state as illustrated in FIG. 5 for disengaging the second coupling pin for releasing the accessory from the coupler 14. Engagement member 158 comprises a pair of spaced apart engagement member side plates 161 affixed to a central block 165, with each member side plate 161 aligned alongside a respective body member side plate 136. A lateral guide flange 160 extends from each engagement member side plate 161, each flange 160 slideably engaging a corresponding guide groove 159 in the corresponding body member side plate 136 for guiding the engagement member 158 between the engaged and disengaged states by way of rectilinear motion. The guide grooves 159 are open at a first end, proximate to the anterior connector plate 139, and extend partially along the side plates 136, terminating at an abutment 157 (depicted in FIG. 7). A single jaw 162 extends from each engagement member side plate 161, and is moveable with the moveable engagement member. Each jaw 162 cooperates with an adjacent edge 163 of the corresponding body member side plate 136 to define a pair of moveable open mouths 164. The moveable open mouths 164 are aligned with one another for accommodating the second coupling pin into and between the jaws 162 and the edges 163 of the side plates 136. It will be appreciated that alternative suitable means may be provided for slidably carrying the moveable engagement member 158 in the body member 135. For example, in one alternative arrangement, a lateral guide flange extends from each body member side plate, each flange slideably engaging a corresponding guide groove in the corresponding engagement member side plate for guiding the engagement member 158 between the engaged and disengaged states by way of rectilinear motion. It will also be appreciated that in alternative arrangements, the moveable engagement member may be moveable in manners other than in a slideable manner. For example, in one alternative arrangement, the moveable engagement member may be pivotally moveable with respect to the body member.

The open mouths 164 face outwardly from the coupler 14 in a direction opposite to the direction in which the fixed open mouths 145 face. Accordingly, when the moveable engagement member 158 is in the engaged state, the first and second coupling pins are securely engaged between the fixed open mouths 145 of the fixed engagement member and the moveable open mouths 164 of the moveable engagement member 158.

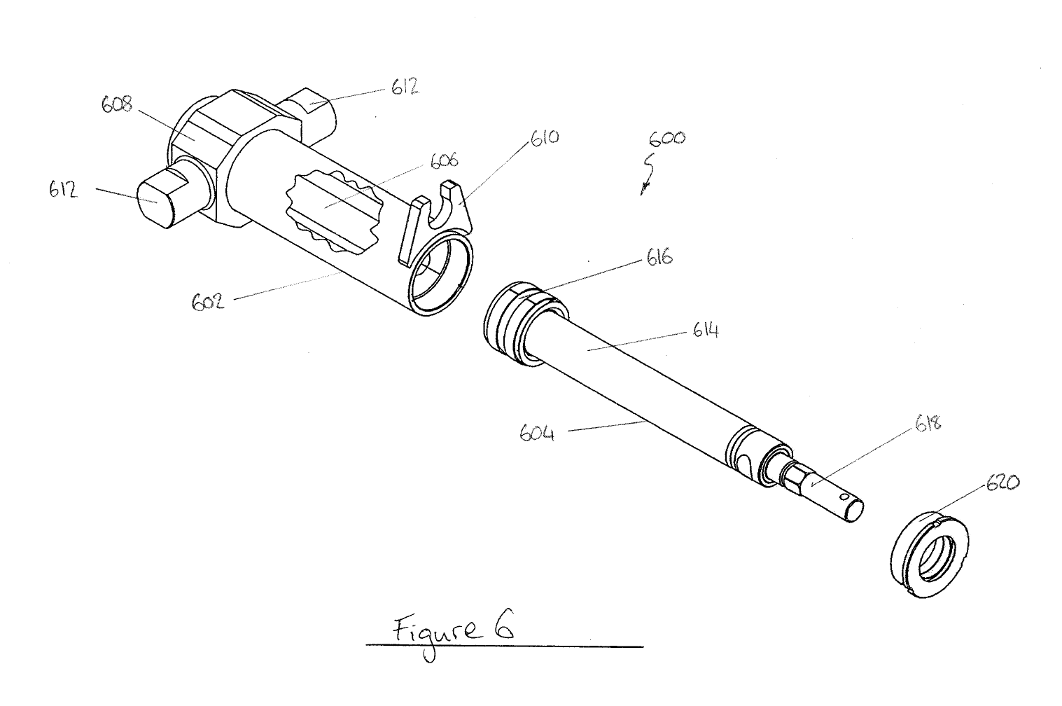

A mechanical ram 600 as depicted in cutaway exploded form in FIG. 6 provides the motive force for sliding the moveable engagement member 158 between an engaged and a disengaged state. The ram 600 comprises a cylinder body 602 and an external rod assembly 604. The cylinder body 602 comprises a cylinder rod 606 housed within the cylinder body 602, an end cap 608 affixed to a first end of the cylinder body 602 such that the first end is sealed, and a ram bracket 610. The ram bracket 610 is affixed to the cylinder body 602, typically at a second end of the body 602. The cylinder rod 606 is affixed to the end cap 608 at the first end of the cylinder body 602, and extends along the longitudinal axis of the cylinder body 602 toward the second end of the body 602. The cylinder rod 606 comprises an external threaded surface. The end cap 608 comprises a pair of ram trunions 612, for allowing the end cap, and thus the cylinder body to be retained by cooperating grooves in the body member, as will be discussed further below.

The external rod assembly 604 comprises a rod assembly body 614, a piston 616 attached to a first end of the rod assembly body 614, and a ram rod 618 extending from a second, opposite, closed end of the rod assembly body 614. The rod assembly body 614 is cylindrical, having an external diameter less than that of the internal diameter of the cylinder body 602 and an internal diameter greater than that of the cylinder rod 606. The piston 616 is also cylindrical, and has an external diameter less than that of the internal diameter of the cylinder body 602 but greater than the external diameter of the rod assembly body 614 and an internal diameter greater than that of the cylinder rod 606. The cylindrical piston 616 is open at both ends and is attached at one of said open ends to the first end of the cylindrical rod assembly body 614, such that piston 616 and body 614 together define a contiguous internal cavity extending along the longitudinal axis of both the piston 616 and body 614. The unattached open end of the piston 616 remains free. Accordingly, the internal cavity remains open at a first end (the free open end of the piston), but is sealed at a second end (the second end of the body 614, to which ram rod 618 is attached). The piston 616 comprises an internal threaded surface of a diameter such that the internal threads of the piston 616 engage the external threads of the cylinder rod 606. The rod assembly body 614 has a smooth internal surface of a diameter sufficient to slidably accommodate the cylinder rod 606. The external surface of the piston 616 is of a diameter such that it is in slidable contact with the internal surface of the cylinder. Accordingly, when in use, rotation of the rod assembly 604 relative to the cylinder body 602 causes the rod assembly 604 to slide in a rectilinear fashion relative to the cylinder body 602, with the piston 616 and rod assembly body 614 slideably and rotatably accommodated within the cylinder body 602, and the cylinder rod 606 slideably and rotatably accommodated within the contiguous internal cavity extending along the longitudinal axis of both the piston 616 and body 614.

The external rod assembly 604 resides at least in part within the cylinder body 602 between the cylinder body 602 and the cylinder rod 606, whereby it is moveable between an in-stroked position wherein the piston 616 abuts the end cap 608 (and the ram 600 is in a retracted state), and an out-stroked position wherein the piston is adjacent the second end of the cylinder body 602 (and the ram 600 is in an extended state). The piston 616 is retained in the cylinder by a retaining ring 620 that is threaded into the second end of the cylinder body. The retaining ring 620 comprises an internal aperture of a diameter that allows the rod assembly body 614 but not the piston 616 to pass through. The ram 600 is transitioned between an in-stroked, retracted state and an out-stroked extended state by rotating the ram assembly clockwise and anticlockwise respectively. Application of clockwise torque to the ram rod 618 causes the ram assembly to rotate clockwise, whereby the internal threads of the piston 616 engage the external threads of the cylinder rod 606, and the ram assembly in-strokes, with the piston 616 both rotating within the cylinder body 602 and sliding rectilinearly toward the end cap 608. Similarly, application of anticlockwise torque to the ram rod 618 causes the ram assembly to rotate anticlockwise, whereby the internal threads of the piston 616 engage the external threads of the cylinder rod 606, and the ram assembly out-strokes, with the piston 616 both rotating within the cylinder body 602 and sliding rectilinearly toward the retaining ring 620.

Referring to the exploded perspective view of the coupler as illustrated in FIG. 7, the mechanical ram 600 is retained in the body member 135 by way of the ram trunions 612 emanating from the end cap 608. Each ram trunion 612 is retained in one of a pair of accommodating ram grooves 730, each ram groove 730 comprised respectively within one of the two side plates 136. The ram grooves are shaped to facilitate movement of the trunions 612 and thus the cylinder body 602 between an advanced position proximal to posterior connector plate 138 and a withdrawn position distal to posterior connector plate 138. A gap 732 in the roof of each groove 730 allows the trunions 612 to be slid into the grooves 730, with a pair of plugs 734 inserted, one into each of the respective gaps 732 to ensure that the trunions 612 do not subsequently slide out of the grooves 730.

The ram 600 is also connected to the body member 135 by way of a biasing means 740. The biasing means 740, preferably a compression spring, is retained at a first end by the ram bracket 610. A second end of the biasing means 740 is retained by a support bracket 742 immovably affixed to a support plate 744 (the support plate 744 is depicted in situ in FIG. 2). The support plate 744 is immovably affixed to the side plates 136 and anterior connector plate 139 such that the plate 744, support bracket 742 and biasing means 740 do not hinder movement of the moveable engagement means 135. The biasing means 740 acts against the immovably affixed support bracket 742 to exert substantially rectilinear force on the ram 600 via the ram bracket 610, biasing the ram 600 toward the posterior connector plate 138 (the advanced position of the ram 600).

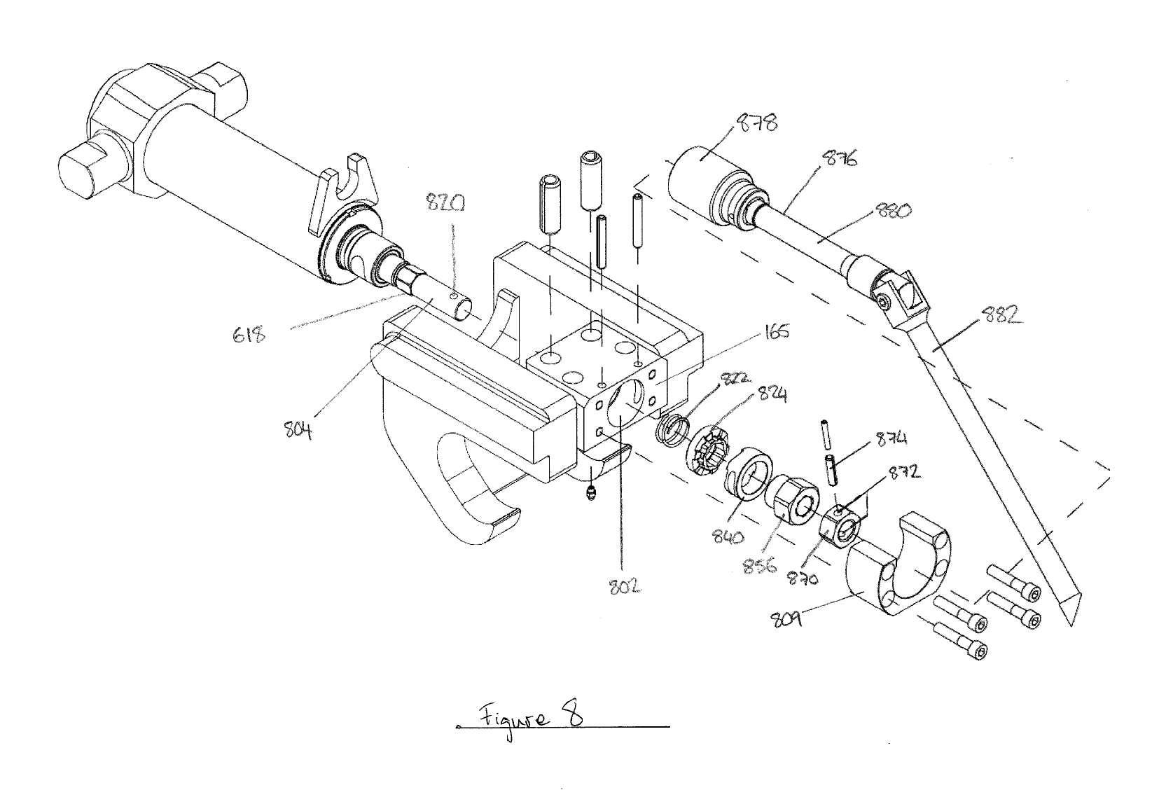

The mechanical ram 600 is further rotatably connected to the moveable engagement member 158 by way of the ram rod 618. As will be discussed in detail in relation to FIGS. 8-10, the ram rod 618 is rotatably retained in the central block 165 of the moveable engagement member.

When the ram 600 is resting in its extended, out-stroked state (and the moveable engagement means 135 is in the engaged position), the ram is biased toward the posterior connector plate 138 by the biasing means. From this state, when the ram 600 begins to in-stroke, the ram rod 618 retracts, as will be described below, toward the cylinder body 602, drawing with it the moveable engagement means 135 via the central block 165. Accordingly, the moveable engagement means 135 moves from an engaged to a disengaged state upon in-stroking of the ram 600. The moveable engagement means is in a fully disengaged state when the guide flanges 160 reach the abutments 157 and can slide no further along guide grooves 159 toward posterior connector plate 138. Because the moveable engagement means 135 can retract no further, additional in-stroking of the cylinder at this point acts against the biasing force of the biasing means 740 to draw the cylinder body 602 from its advanced position to its withdrawn position. It will be understood that the force applied to in-stroke the ram 600 must be greater than the biasing force of the biasing means 740 for the cylinder body to move to its withdrawn position in this way.

When the ram 600 is resting in its retracted, in-stroked state (and the moveable engagement means 135 is in the disengaged position), the opposite occurs. Out-stroking of the ram 600 initially releases the cylinder body 602 such that the biasing means 740 pushes it into its advanced state. When the cylinder body is fully advanced such that it can move no further along the ram grooves 730, further out-stroking causes the ram rod 618 to act against the moveable engagement means 135 via the central block 165 to slide the moveable engagement means into its engaged state.

As depicted in FIG. 7, a lock linkage 702 is pivotally mounted between the body member side plates 136 proximate to the posterior connector plate 138. The lock linkage comprises a latch link 704 pivotally connected to a parallel pair of connector links 706. A pair of latch trunions 708 emanate from opposing sides of the latch link 704, each trunion 708 residing in a complementary link aperture 710 in a respective body member side plate 136. The connector links 706 each further comprise a trunion aperture 703 through which a respective ram trunion 612 passes before the trunions 612 engage their corresponding ram grooves 730 such that each connector link 706 is pivotally held on a respective ram trunion 612 between the end cap 608 and the respective side plate 136. Accordingly, the connector links 706 are pivotally connected at a first end to the ram 600, and at a second end, pivotally connected to the latch link 704. The latch link 704, in turn is pivotally connected to the body member side plates 136. The connector links 706 and latch link 704 are thus connected to form a lock linkage in such a way that movement of the ram 600 from the retracted, in-stroked state to the extended, out-stroked state in turn causes the lock linkage to move from an unlocked state to a locked state. In an unlocked state, the distance between the ram trunions 612 and the link apertures 710 is such that the lock linkage 702 is retained in the body 135 member. In a locked state, the distance between the ram trunions 612 and the link apertures 710 is reduced. This has the effect of causing the connector links 706 and the latch link 704 to pivot with respect to one another, and to pivot with respect to the body member 135 such that the section of the lock linkage 702 defined by the pivot point between the latch link 704 and the connector links 706 is forced downward toward the space defined by the open mouths 145. As depicted in FIG. 4, when the lock linkage 702 is moved into this position, a connector pin residing in the open mouths 145 is abutted by, and thus held in place by, the section of the lock linkage 702 defined by the pivot point between the latch link 704 and the connector links 706, thereby locking the pin in place. Stated another way, when the lock linkage 702 is moved into this position, it restricts egress from the mouths, and thus a connector pin residing in the open mouths is held in place.

As can be seen in FIGS. 8, 9 and 10, the ram rod 618 comprises a free end 804 that passes through a bore 802 in the central block 165. The bore 802 comprises a central bore section 808, a first end bore section 806, and a second end bore section 810. The central bore section 808 has a first mouth facing the first end bore section 806 and a second mouth facing the second end bore section 810. The central bore section 808 is of a lesser internal diameter than the internal diameter of either the first or second end bore sections 806, 810. A horseshoe shaped guard 809 extends from the central block 165 around the mouth of the second bore section 806, such that the free end 804 of the ram rod does not protrude out beyond the guard 809. A space is maintained between the guard 809 and the free end 804 of the ram rod.

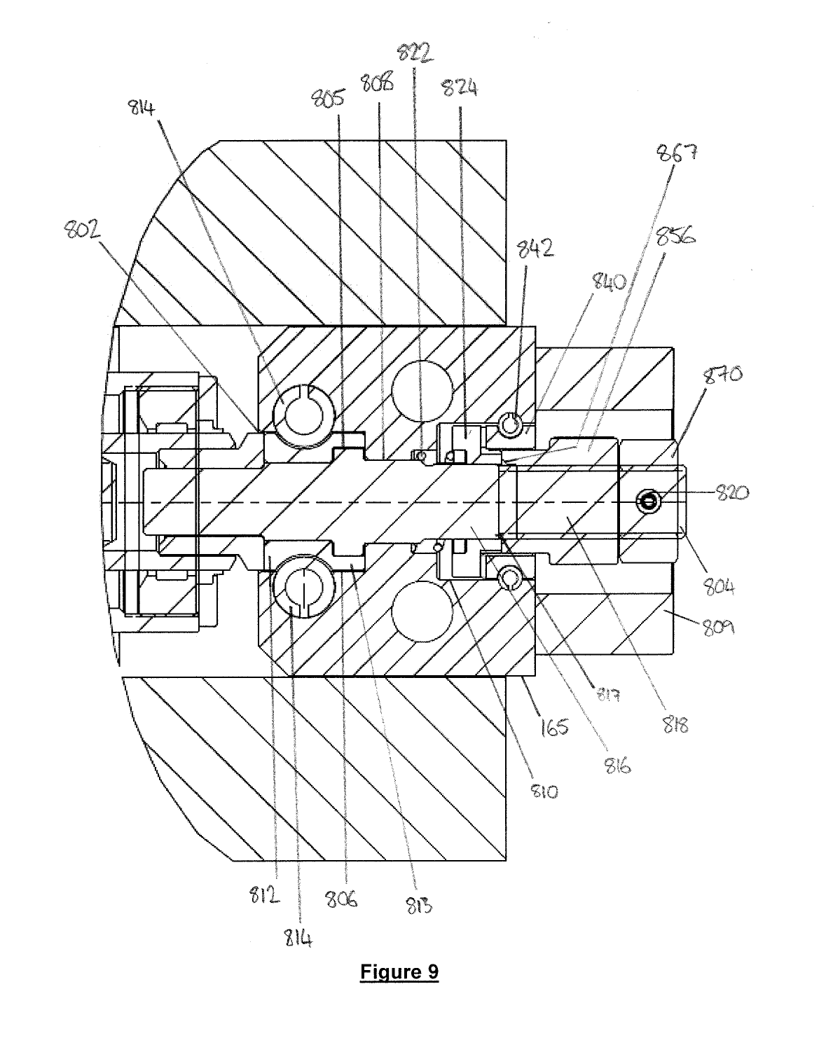

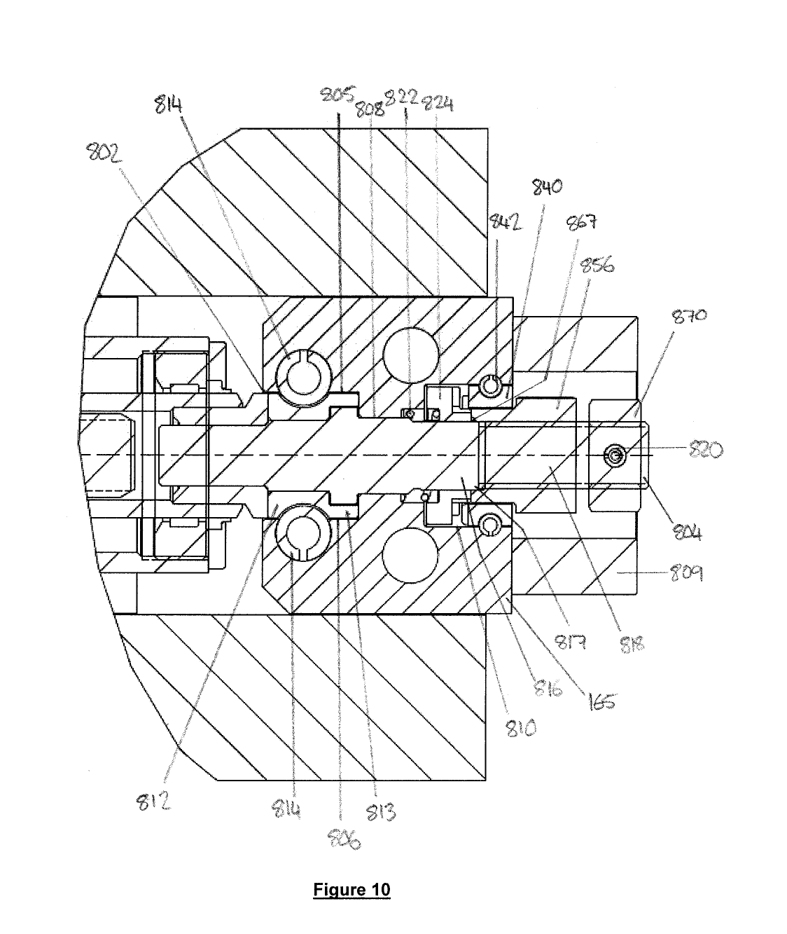

The ram rod is rotatably anchored to the central block 165 by way of a circumferential flange 805 extending radially from the ram rod around its circumference proximal to the free end 804 of the ram rod. The flange 805 has an external diameter greater than the internal diameter of the central bore section 808, but a lesser external diameter than internal the diameter of the first end bore section 806. The free end 804 of the ram rod protrudes through the bore 802 such that the circumferential flange 805 resides in the first end bore section 806, the flange 805 abutting the first mouth of the central bore section 808. A retaining bush 812 with an internal diameter that is less than the external diameter of the circumferential flange 805 resides around the ram rod between the circumferential flange 805 and the cylinder body of the mechanical ram 600. The retaining bush 812 is securely retained in the mouth of the first end bore section 806 by way of roll pins 814, such that the circumferential flange 805 is securely retained in the first end bore section 806 between the retaining bush 812 and the first mouth of the central bore section 808. As the ram rod is retained in this way, rotation of the ram rod about its longitudinal axis is unhindered, as the ram rod comprising the circumferential flange rotates freely in the bore 802 without transferring this rotational force to the central block 165. By contrast, rectilinear force applied to the ram rod along its longitudinal axis is transferred to the central block 165 by way of the circumferential flange 805 abutting either the first mouth of the central bore section 808 or the retaining bush 812. Free rotation of the ram rod may be improved through use of a flanged bush as the retaining bush 812, as depicted in FIGS. 9 and 10. The flanged retaining bush 812 further comprises an intervening flange 813 extending longitudinally from one face of the retaining bush body such that the intervening flange extends between the circumferential flange of the ram rod and the internal surface of the first end bore section. Such an intervening flange can reduce rotational friction and facilitate ram rod rotation.

The second end bore section 810 houses a safety locking mechanism for permitting only unidirectional rotation of the ram rod when in a “locked” configuration, as will be described in detail below. Between the circumferential flange and the free end 804 of the ram rod, the ram rod comprises a portion having a hexagonal cross section (a hexagonal portion) 816, and at the free end, a threaded portion 818, and a ram rod aperture 820. The threaded portion 818 is of a lesser diameter than the hexagonal cross-section portion 816, such that a slight step 817 exists between the two portions. A compression spring 822 with an internal diameter greater than the external diameter of the hexagonal portion 816 of the ram rod, and with an external diameter greater than the internal diameter of the central bore section 808 resides around the hexagonal portion 816 of the ram rod. The compression spring 822 is situated in the second end bore section 810, with a first end of the spring abutting the second mouth of the central bore section 808.

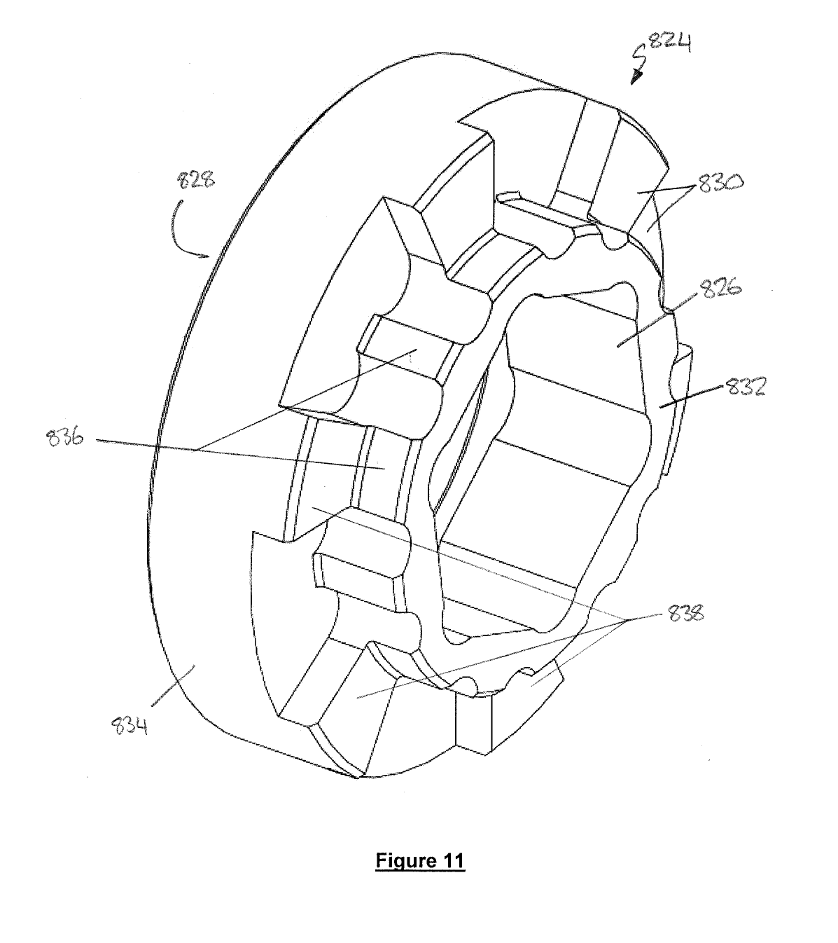

A moving lock bush 824 resides around the hexagonal portion 816 of the ram rod and is situated in the second end bore section 810 between the compression spring 822 and the mouth of the second end bore section 810. As is depicted in FIG. 11, the moving lock bush 824 comprises an interior surface 826, a first exterior surface 834 and a second exterior surface 836, wherein the first exterior surface 834 is of a greater diameter than the second exterior surface 836. The cross section of the interior surface 826 is shaped substantially hexagonally such that, when the moving lock bush 824 resides around the hexagonal portion 816 of the ram rod, the interior surface 826 accommodates and mates with the hexagonal portion 816 of the ram rod, such that the moving lock bush may slide along the longitudinal axis of the ram rod, but such that torque applied to the ram rod is equally applied to the moving lock bush 824. The moving lock bush 824 further comprises a posterior face 828, a first anterior face 830, and a second anterior face 832. The first anterior face 830 extends substantially perpendicularly from the first exterior surface 834 to the second exterior surface 836. The second exterior surface 836 in turn extends substantially perpendicularly from the first anterior face 830 to the second anterior face 832. In turn, the second anterior face 832 extends substantially perpendicularly between the second exterior surface 836 and the interior surface 826. Accordingly, the first anterior face 830 may be regarded as a recessed outer anterior face of the moving lock bush 824, while the second anterior face 832 may be regarded as a protruding inner anterior face of the moving lock bush 824. The first anterior face 830 of the moving lock bush 824 comprises a series of ratchet teeth 838 for engaging complementary angled ratchet teeth in a fixed lock bush as will be further described below.

It will be appreciated that while the moving lock bush 824 is described as cooperating with the hexagonal portion of the ram rod, other means of transferring torque from the ram rod to the moving lock bush 824 are also contemplated. For example, the hexagonal portion of the ram rod may instead comprise a splined portion or a keyed portion, with the interior surface 826 of the moving lock bush 824 configured to accommodate and mate with the respective splines or keys in such a way that torque applied to the ram rod is equally applied to the moving lock bush but that allows free movement of the moving lock bush along the longitudinal axis of the ram rod.

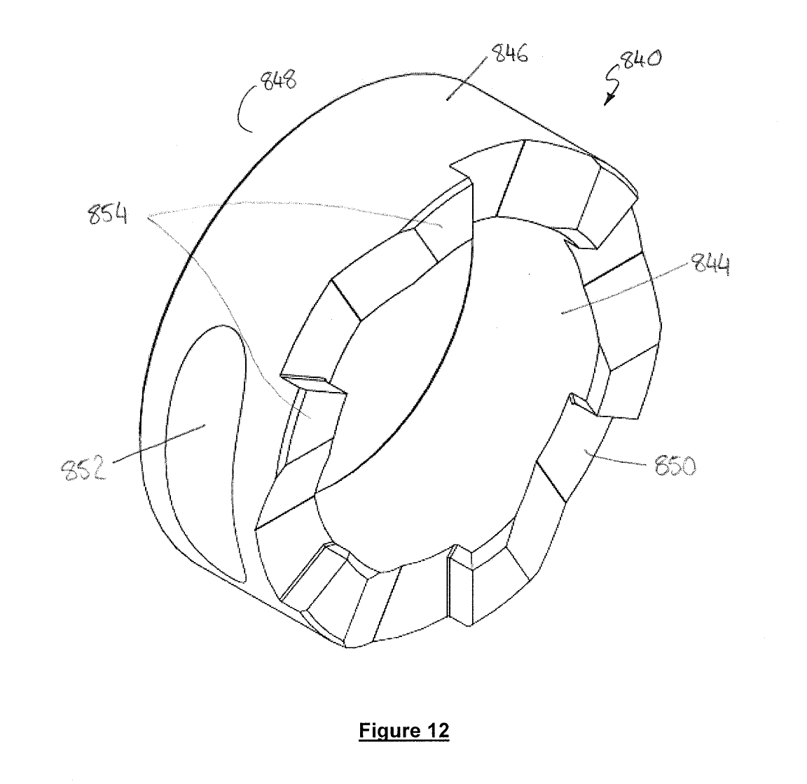

Turning to FIG. 12, a fixed lock bush 840 with an internal diameter that is less than the external diameter of the first exterior surface 834 of the moving lock bush 824 but greater than the external diameter of the second exterior surface 836 of the moving lock bush 824 resides around the ram rod between the moving lock bush 824 and the free end of the ram rod 804. As can be seen, the fixed lock bush 840 comprises an interior surface 844, an exterior surface 846, an anterior face 848, and a posterior face 850. The exterior surface 846 comprises grooves 852 to allow the fixed lock bush to be securely retained in the mouth of the second end bore section 810 by way of retaining pins 842, as shown in FIG. 9. The interior surface 844 of the fixed lock bush 840 is smooth to allow free rotation of elements residing therein. The posterior face 850 of the fixed lock bush 840 comprises angled ratchet teeth 854 for cooperating with the ratchet teeth 838 of the first anterior face 830 of the moving lock bush 824.

Returning to FIGS. 8-10. the fixed lock bush 840 is securely retained in the mouth of the second end bore section 810 by way of retaining pins 842, such that the moving lock bush 824 is securely retained in the second end bore section 810 between the fixed lock bush 840 and the compression spring 822. The fixed lock bush is held such that the posterior face 850 faces into the bore 802 toward the central bore section 808. A first end of the compression spring 822 abuts the second mouth of the central bore section 808 and a second end of the compression spring 822 abuts the posterior face 828 of the moving lock bush 824, such that the compression spring 822 exerts a longitudinal force on the moving lock bush 824 urging it away from the mouth of the central bore section 808. As previously stated, the moving lock bush 824 is free to slide along the longitudinal axis of the ram rod, and the moving lock bush is therefore urged by the longitudinal force of the compression spring 822 toward the fixed lock bush 840. Because the internal diameter of the fixed lock bush 840 is greater than the external diameter of the second exterior surface 836 of the moving lock bush 824, the second anterior face 832 of the moving lock bush (the protruding inner anterior face) passes through the fixed lock bush 840 until the first anterior face 830 (the recessed outer anterior face) of the moving lock bush 824 abuts the posterior face 850 of the fixed lock bush, and the angled ratchet teeth 854 of the fixed lock bush 840 engage the ratchet teeth of the moving lock bush 824.

A stop ferrule 870 is located at the free end 804 of the ram rod. The stop ferrule 870 has an internal diameter sufficiently large to allow it to reside on the end of the ram rod. A pair of stop apertures 872 pass through the ferrule at opposing points on its diameter, and the ferrule resides on the end of the ram rod, such that the stop apertures 872 are aligned with the ram rod aperture 820. A retaining pin passes through the stop apertures 872 and the ram rod aperture 820 for securely retaining the stop ferrule at the free end 804 of the ram rod. Typically, the stop ferrule 870 has an internal thread that allows it to be screwed onto the threaded portion 818 of the ram rod free end 804 until the stop apertures 872 are aligned with the ram rod aperture.

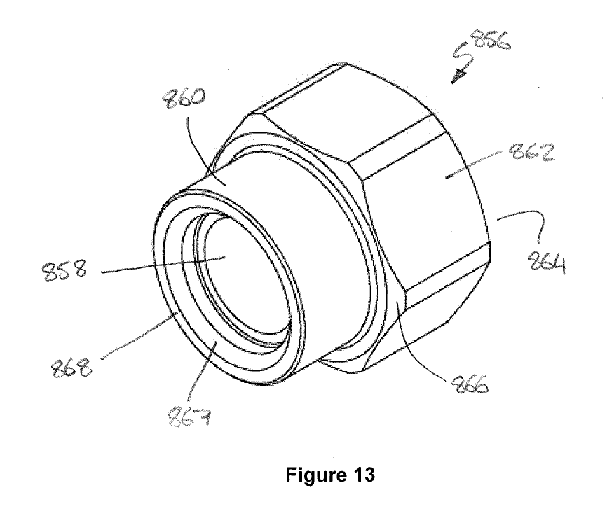

A lock nut 856 resides around the threaded portion 818 of the ram rod and is situated primarily between the fixed lock bush 840 and the free end 804 of the ram rod. As is depicted in FIG. 13, the lock nut 856 comprises an interior surface 858, a first exterior surface 860 and a second exterior surface 862. The external diameter of the first exterior surface 860 is less than the external diameter of the second exterior surface 862, and is also less than the internal diameter of the interior surface 844 of the fixed lock bush 840. The interior surface 858 is threaded so as to cooperate with the threads on the threaded portion 818 of the ram rod such that the lock nut 856 may be moved along the longitudinal axis of the ram rod in either direction by respective clockwise or anticlockwise rotation of the lock nut 856. The second exterior surface 862 is typically of hexagonal cross-section in the manner of a nut, so as to allow easy rotation of the lock nut 856. The lock nut 856 further comprises an anterior face 864, a recessed outer posterior face 866 and a protruding inner posterior face 868. The protruding inner posterior face 868 is connected to the interior surface 858 via a chamfered edge 867. When in situ, the protruding inner posterior face 868 extends through the fixed lock bush 840 and into the second end bore section 810 such that the protruding inner posterior face 868 abuts the second anterior face 832 of the moving lock bush 824 (which is urged against the protruding inner posterior face 868 by the compression spring 822). When residing in situ on the threaded portion of the ram rod, the lock nut may be moved longitudinally along the ram rod (by way of rotation), and this in turn moves the moving lock bush 824 in the same direction, between a locked position and an unlocked position.

In the locked position (as depicted in FIG. 9), the lock nut 856 has been rotated anticlockwise until its anterior face 864 abuts the stop ferrule 870, and the protruding inner posterior face 868 is partially withdrawn from the fixed lock bush 840. The moving lock bush 824 is urged toward the protruding inner posterior face 868 by the compression spring 822 such that the ratchet teeth 838 of the first anterior face 830 of the moving lock bush 824 engage the angled ratchet teeth 854 of the posterior face 850 of the fixed lock bush 840.

In the unlocked position (as depicted in FIG. 10), the lock nut 856 has been rotated clockwise such that the protruding inner posterior face 868 is fully extended into the fixed lock bush 840 until the chamfered edge 867 abuts the step 817 on the ram rod between the threaded portion 818 and the hexagonal cross-sectional portion 816. As in the locked position, the moving lock bush 824 is urged toward the protruding inner posterior face 868 by the compression spring 822. However due to the extent to which the inner posterior face 868 is extended into the fixed lock bush 840, the ratchet teeth 838 of the first anterior face 830 of the moving lock bush 824 are distanced from, and therefore do not engage, the angled ratchet teeth 854 of the posterior face 850 of the fixed lock bush 840.

Torque may be applied to the lock nut 856 by way of a crank 876. As depicted in FIG. 8, the crank 876 comprises a socket 878, affixed to an extension bar 880, which is in turn hingedly linked to a drive bar 882. The socket 878 is shaped to accommodate and mate with the lock nut 856 without hindrance from the guard 809 such that torque applied to the socket is transferred to the lock nut. Torque may be applied to the socket by the drive bar 882 via the extension bar 880. The crank 876 may be used to manually apply torque to the lock nut 856. The crank 876 may be applied to and removed from the lock nut 856 as required.

When the lock nut 856 is rotated anticlockwise until it has moved fully to the locked position, it cannot move further away from the bore 802 because it abuts the stop ferrule 870. While the lock nut 856 is in the locked position, clockwise rotation of the ram rod is restricted, but further anticlockwise rotation is possible. If further anticlockwise torque is applied to the lock nut 856 in this state (by way of the crank 876), this torque is transferred to the ram rod, causing the ram rod to rotate in an anticlockwise fashion. This has the effect of out-stroking the ram cylinder, and because the ram rod is secured to the central block 165 by way of circumferential flange 805, this in turn extends the central block 165 and thus the whole moveable engagement member 158 into an engaged state.

When the crank 876 is used to move the engagement member 158 into an engaged state, the crank 876 is then removed before the accessory is used. When the crank has been used in this way, the lock nut 856 is left in the locked position. This therefore prevents accidental in-stroking of the cylinder, because clockwise rotation of the ram is restricted by the moving lock bush 824 engaging the fixed lock bush 840, as has already been described and will be described in further detail below. As will be understood, the application of anticlockwise torque for out-stroking the cylinder, and for moving the moveable engagement member 158 to an engaged state, first transitions the lock nut 856 to the locked position. Accordingly, the process of engaging the locking system is integrated into the process of moving the moveable engagement member 158 to an engaged state, and ensures that the lock nut 856 is always left in a locked state when the moveable engagement member 158 is moved to an engaged state. This circumvents the problem of independent locking mechanisms where the user often forgets to engage the locking mechanism once a moveable engagement member has engaged an accessory.

When the crank 876 is used to rotate the lock nut 856 clockwise until it has moved fully to the unlocked position, it cannot move further toward the bore 802 because the chamfer 867 abuts the step 817 on the ram rod between the threaded portion 818 and the hexagonal cross-section portion 816. Because the lock nut is in the unlocked position, the ram rod is free to rotate in both clockwise and anticlockwise directions. If further clockwise torque is applied to the lock nut 856 in this state (by way of the crank 876), this torque is transferred to the ram rod, causing the ram rod to rotate in a clockwise fashion, because the lock nut 856 cannot move further forward toward the bore 802. This has the effect of in-stroking the ram cylinder, and because the ram rod is secured to the central block 165 by way of circumferential flange 805, this in turn retracts the central block 165 and thus the whole moveable engagement member 158 into a disengaged state.

When the ram rod is extended out of the ram cylinder, and the moveable engagement member 158 is in an engaged state, the ram may come under pressure to retract by external forces acting on the moveable engagement member 158 itself. Because the ram is of a screw-threaded design, this pressure to retract translates into clockwise torque being applied to the ram rod. However, when the lock nut 856 resides in the locked position, such clockwise torque is resisted, and the ram rod is restricted from rotating in a clockwise fashion. Because the lock nut is in the locked position, the protruding inner posterior face 868 is partially withdrawn from the fixed lock bush 840, and thus—as previously described—the moving lock bush 824 is urged toward the protruding inner posterior face 868 by the compression spring 822 such that the ratchet teeth 838 of the first anterior face 830 of the moving lock bush 824 engage the angled ratchet teeth 854 of the posterior face 850 of the fixed lock bush 840. Clockwise torque applied to the ram rod is transferred to the moving lock bush 824 by way of the interior surface 826 of the moving lock bush 824 mating with the hexagonal portion 816 of the ram rod. The moving lock bush 824 rotates slightly until its ratchet teeth 838 engage the angled ratchet teeth 854 of the fixed lock bush (if not already engaged), at which point the clockwise torque applied to the moving lock bush is transferred to the fixed lock bush 840. As the fixed lock bush 840 is immobilised in the central block 165, this clockwise torque is resisted, and this resistance is thereby transferred to the ram rod via the moving lock bush 824. Accordingly, the ram rod is restricted from rotating in a clockwise fashion. By contrast, if anticlockwise torque is applied to the ram rod while the lock nut 856 is in the locked position, the ratchet teeth 838 of the first anterior face 830 of the moving lock bush 824 slide over the angled ratchet teeth 854 of the posterior face 850 of the fixed lock bush 840, thereby allowing rotation of the ram rod in an anticlockwise fashion.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination. For example, while one of the embodiments of the invention described comprises both lock linkage 702 and the rotational locking system comprised primarily of moving lock bush 824, fixed lock bush 840, and lock nut 856, other embodiments of the invention comprise only one or other of the lock linkage 702 and said rotational locking system.

The words “comprises/comprising” and the words “having/including” when used herein with reference to the present invention are used to specify the presence of stated features, integers, steps or components but does not preclude the presence or addition of one or more other features, integers, steps, components or groups thereof

Parts list

| | |
|---|---|
| 2 | Main housing |
| 3 | Ground engaging tracks |
| 4 | Boom |
| 5 | Dipper arm |
| 7 | Earth moving bucket |
| 8 | Dipper arm operating ram |
| 14 | Quick hitch coupler |
| 18 | Pivotally mounted connecting linkage |
| 20 | Excavator apparatus |
| 21 | back actor arm |
| 22 | Boom operating rams |
| 24 | Accessory operating ram |
| 135 | Body member |
| 136 | Spaced apart side plates |
| 136c | Main side plate |
| 136b | Reinforcing side plate |
| 136a | Reinforcing side plate |
| 138 | Posterior connector plate |
| 139 | Anterior connector plate |
| 140 | Bushed bore |
| 141 | Bushed bore |
| 145 | Fixed open mouths |
| 157 | Abutment |
| 158 | Moveable engagement member |
| 159 | Guide groove |
| 160 | Guide flange |
| 161 | Engagement member side plate |
| 162 | Single Jaw |
| 164 | Moveable open mouths |
| 165 | Central Block |
| 600 | Mechanical Ram |
| 602 | Cylinder body |
| 604 | External rod assembly |
| 606 | cylinder rod |
| 608 | End cap |
| 610 | Ram bracket |
| 612 | ram trunion |
| 614 | Rod assembly body |
| 616 | Piston |
| 618 | Ram rod |
| 620 | Retaining ring |
| 702 | Lock linkage |
| 703 | Trunion aperture |
| 704 | Latch link |
| 706 | Connector link |
| 708 | Latch trunion |
| 710 | link aperture |
| 730 | Ram groove |
| 740 | Biasing means |
| 742 | Support bracket |
| 744 | Support plate |
| 802 | Bore |
| 804 | Free end of ram |
| 805 | Circumferential flange |
| 806 | First end bore section |
| 808 | Central bore section |
| 810 | Second end bore section |
| 809 | horseshoe shaped guard |
| 812 | Retaining bush |
| 814 | Roll pins |
| 816 | Ram hexagonal portion |
| 817 | Step |
| 818 | Ram threaded portion |
| 820 | Ram Rod Aperture |
| 822 | Compression spring |
| 824 | Moving lock bush |
| 826 | Interior surface |
| 828 | Posterior face |
| 830 | First anterior face |
| 832 | Second anterior face |
| 834 | First exterior surface |
| 836 | Second exterior surface |
| 838 | Ratchet teeth |
| 840 | Fixed lock bush |
| 842 | Roll pins |
| 844 | Interior surface |
| 846 | Exterior surface |
| 848 | Anterior face |
| 850 | Posterior face |
| 852 | Grooves |
| 854 | Angled ratchet teeth |
| 856 | Lock nut |
| 858 | Interior surface |
| 860 | First exterior surface |
| 862 | Second exterior surface |
| 864 | Anterior face |
| 866 | Recessed outer posterior face |
| 867 | Chamfer |
| 868 | Protruding inner posterior face |
| 870 | Stop ferrule |
| 872 | Stop aperture |
| 874 | Retaining pin |
| 876 | Crank |
| 878 | Socket |
| 880 | Extension bar |
| 882 | drive bar |

1. An extendable mechanism, moveable through a plurality of states, wherein the plurality of states comprises at least a first state and a second state, the mechanism comprising:
a force receiving member wherein application of a force of a first type to the force receiving member results in the extendable mechanism moving toward the first state, and wherein application of a force of a second type to the force receiving member results in the mechanism moving toward the second state, and
a locking member in communication with the force receiving member, the locking member moveable between a locked configuration and an unlocked configuration;
wherein when in the locked configuration, the locking member restricts movement of the extendable mechanism toward the first state;
and wherein:
application of the first type of force to the force receiving member results in the locking member moving to the unlocked configuration; and
application of the second type of force to the force receiving member results in the locking member moving to the locked configuration.

2. The extendable mechanism as claimed in claim 1, wherein the first state is a retracted state, and the second state is an extended state.

3. The extendable mechanism as claimed in claim 1, wherein the force receiving member is configured to rotate about an axis, and wherein the first type of force is a first torque, and the second type of force is a second torque, the first and second torques being torque of opposing rotations.

4. The extendable mechanism as claimed in claim 3, wherein the first type of force is clockwise torque, and the second type of force is anticlockwise torque.

5. The extendable mechanism as claimed in claim 3, further comprising a mechanical ram comprising a cylinder body and a ram rod, and wherein rotation, relative to the cylinder body, of the ram rod about a longitudinal axis of the cylinder body causes the ram rod to move relative to the cylinder body along the longitudinal axis of the cylinder body.

6. The extendable mechanism as claimed in claim 5, wherein the force receiving member and the locking member are in communication with the ram rod, such that:
the first torque applied to the force receiving member is transferred to the ram rod, urging the ram rod to rotate in a first direction, such that the extendable mechanism would move toward the first state;
the second torque applied to the force receiving member is transferred to the ram rod, urging the ram rod to rotate in a second direction, such that the extendable mechanism would move toward the second state; and
when in the locked configuration, the locking member restricts rotation of the ram rod in the first direction.

7. The extendable mechanism as claimed in claim 1, further comprising a biasing means configured to urge the locking member against the force receiving member, such that:
the application of the first type of force to the force receiving member urges the force receiving member against the locking member, urging the locking member against the biasing means in turn, such that the locking member is moved to the unlocked configuration; and
the application of the second type of force to the force receiving member urges the force receiving member away from the locking member, wherein the biasing means further urges the locking member against the force receiving member, such that the locking member is moved to the locked configuration.

8. The extendable mechanism as claimed in claim 7, wherein the biasing means comprises a compression spring.

9. The extendable mechanism as claimed in claim 1, wherein the extendable mechanism is incorporated into a coupling device for coupling an attachment to an arm.

10. The extendable mechanism as claimed in claim 9, wherein the coupling device is a quick hitch coupler.

11. The extendable mechanism as claimed in claim 9, wherein the coupling device is a dedicated coupler.

12. An excavator arm comprising an extendable mechanism as claimed in claim 1.

13. An excavator comprising the excavator arm as claimed in claim 12.

14. A quick hitch coupler comprising:
a coupler body, defining at least one fixed mouth;
a latch member having a first end and a second end, and pivotally attached at the first end to the coupler body, the latch member moveable between an unlocked position, and a locked position, wherein in the locked position the latch member restricts egress from the at least one fixed mouth;
an engagement member defining at least one moveable mouth, the engagement member moveable relative to the coupler body between a first position where the at least one moveable mouth is proximate to the at least one fixed mouth, and a second position where the at least one moveable mouth is distant from the at least one fixed mouth; and
an extendable mechanism moveable between an extended and a retracted state through application of mechanical force, the extendable mechanism having a first end and a second end, the first end of the extendable mechanism retained in the coupler body and connected to a second end of the latch member, and the second end of the extendable mechanism rotatably connected at a second end to the engagement member,
wherein movement of the extendable mechanism toward the retracted state results in the movement of the engagement member toward the first position and movement of the latch member to the unlocked position, and movement of the extendable mechanism toward the extended state results in the movement of the engagement member toward the second position and movement of the latch member to the locked position.

15. The quick hitch coupler as claimed in claim 14, wherein the latch member comprises at least two links pivotally connected at a common pivot point, and wherein in the locked position, the portion of the latch member comprising the common pivot point restricts egress from the at least one said mouth.

16. The quick hitch coupler as claimed in claim 15, wherein the latch member further comprises a parallel pair of connector links and a latch link, each connector link comprising a first end and a second end, wherein:
the first ends of the connector links are connected to the latch link at the common pivot point;
the second ends of the connector links together comprise the second end of the latch member such that the second ends of the connector links are each pivotally connected to opposing sides of the first end of the extendable mechanism,
the latch link comprises the first end of the link member; and
the extendable mechanism is slidably retained in the coupler body.

17. The quick hitch coupler as claimed in claim 14, wherein the extendable mechanism comprises:
a force receiving member wherein application of a force of a first type to the force receiving member results in the extendable mechanism moving toward the first state, and wherein application of a force of a second type to the force receiving member results in the mechanism moving toward the second state,
a locking member in communication with the force receiving member, the locking member moveable between a locked configuration and an unlocked configuration; and
a mechanical ram comprising a cylinder body and a ram rod, and wherein rotation, relative to the cylinder body, of the ram rod about a longitudinal axis of the cylinder body causes the ram rod to move relative to the cylinder body along the longitudinal axis of the cylinder body,
wherein when in the locked configuration, the locking member restricts movement of the extendable mechanism toward the first state;
wherein:
application of the first type of force to the force receiving member results in the locking member moving to the unlocked configuration; and
application of the second type of force to the force receiving member results in the locking member moving to the locked configuration;
wherein the force receiving member is configured to rotate about an axis, and wherein the first type of force is a first torque, and the second type of force is a second torque, the first and second torques being torque of opposing rotations; and
wherein the first end of the extendable mechanism comprises the cylinder body, and the second end of the extendable mechanism comprises the ram rod.

18. (canceled)

19. (canceled)
